(19) United States
(12) Patent Application Publication
(10) Pub. No.: US 2014/0369078 A1
(43) Pub. Date: Dec. 18, 2014

(54) BRIDGE CONVERTER WITH SNUBBER CIRCUIT

(71) Applicant: Chicony Power Technology Co., Ltd., New Taipei City (TW)

(72) Inventors: Zhen-Yuan WU, New Taipei City (TW); Tim-Cheung LEUNG, New Taipei City (TW)

(21) Appl. No.: 14/304,506

(22) Filed: Jun. 13, 2014

(30) Foreign Application Priority Data
Jun. 14, 2013 (TW) 102211123

(51) Int. Cl. H02M 3/335

(52) U.S. Cl. CPC H02M 3/33576
USPC 363/17

(57) ABSTRACT

A bridge converter with a snubber circuit is applied to a power apparatus and a load apparatus. The bridge converter includes a transformer, a first diode, a secondary side first switch unit, a first capacitor, a second diode, a second capacitor, a secondary side second switch unit, a direct current to direct current conversion unit, a third capacitor and a resistor. The transformer includes a primary side winding, a first secondary side winding and a second secondary side winding.

### BACKGROUND OF THE INVENTION

1. Field of the Invention

The present invention relates to a bridge converter, and especially relates to a bridge converter with a snubber circuit.

2. Description of the Related Art

A resistor for reducing the peak voltage is arranged in the back of a diode which is connected to a transistor switch in the secondary side of a related art switching power supply. Since the dissipated leakage energy of the related art switching power supply on the resistor is high ,the temperature rise on the resistor is high, the packaging size of the resistor mentioned above shall be large and the overall efficiency is low.

### SUMMARY OF THE INVENTION

In order to solve the above-mentioned problems, an object of the present invention is to provide a bridge converter with a snubber circuit.

The bridge converter is electrically connected to the power apparatus and the load apparatus. The bridge converter comprises a transformer, a first diode, a secondary side first switch unit, a first capacitor, a second diode, a second capacitor, a secondary side second switch unit, a direct current to direct current conversion unit, a third capacitor and a resistor. The transformer comprises a primary side winding, a first secondary side winding and a second secondary side winding. The first diode is electrically connected to the first secondary side winding. The secondary side first switch unit is electrically connected to the first secondary side winding, the first diode and the load apparatus. The first capacitor is electrically connected to the first diode, the secondary side first switch unit and the load apparatus. The second diode is electrically connected to the second secondary side winding, the first diode and the first capacitor. The second capacitor is electrically connected to the first diode, the second diode, the first capacitor, the secondary side first switch unit and the load apparatus. The secondary side second switch unit is electrically connected to the second secondary side winding, the second diode, the first capacitor, the second capacitor, the secondary side first switch unit and the load apparatus. The direct current to direct current conversion unit is electrically connected to the first diode, the second diode, the first capacitor and the second capacitor. The third capacitor is electrically connected to the direct current to direct current conversion unit, the first capacitor, the second capacitor, the secondary side first switch unit, the secondary side second switch unit and the load apparatus. The resistor is electrically connected to the direct current to direct current conversion unit, the third capacitor and the load apparatus.

Moreover, the bridge converter further comprises a choke electrically connected to the first secondary side winding, the second secondary side winding, the resistor and the load apparatus.

Moreover, the bridge converter further comprises a fourth capacitor electrically connected to the choke, the resistor, the first capacitor, the second capacitor, the third capacitor, the secondary side first switch unit, the secondary side second switch unit and the load apparatus.

Moreover, the bridge converter further comprises a control unit electrically connected to the secondary side first switch unit and the secondary side second switch unit.

Moreover, the bridge converter further comprises a primary side first switch unit electrically connected to the control unit, the power apparatus and the primary side winding.

Moreover, the bridge converter further comprises a primary side second switch unit electrically connected to the control unit, the power apparatus, the primary side winding and the primary side first switch unit.

Moreover, the bridge converter further comprises a primary side third switch unit electrically connected to the control unit, the power apparatus, the primary side winding and the primary side first switch unit.

Moreover, the bridge converter further comprises a primary side fourth switch unit electrically connected to the control unit, the power apparatus, the primary side winding, the primary side second switch unit and the primary side third switch unit.

Moreover, the control unit is a microprocessor or a microcontroller.

Moreover, the secondary side first switch unit is a metal oxide semiconductor field effect transistor, a bipolar junction transistor, an insulation gate bipolar transistor or a silicon controlled rectifier. The secondary side second switch unit is a metal oxide semiconductor field effect transistor, a bipolar junction transistor, an insulation gate bipolar transistor or a silicon controlled rectifier. The primary side first switch unit is a metal oxide semiconductor field effect transistor, a bipolar junction transistor, an insulation gate bipolar transistor or a silicon controlled rectifier. The primary side second switch unit is a metal oxide semiconductor field effect transistor, a bipolar junction transistor, an insulation gate bipolar transistor or a silicon controlled rectifier. The primary side third switch unit is a metal oxide semiconductor field effect transistor, a bipolar junction transistor, an insulation gate bipolar transistor or a silicon controlled rectifier. The primary side fourth switch unit is a metal oxide semiconductor field effect transistor, a bipolar junction transistor, an insulation gate bipolar transistor or a silicon controlled rectifier.

The efficiency of the present invention is to decrease the working temperature of the bridge converter, reduce the energy consumption, and improve the overall efficiency of the bridge converter.

### BRIEF DESCRIPTION OF DRAWING

FIG. 1 shows a block diagram of the bridge converter of the present invention.

### DETAILED DESCRIPTION OF THE INVENTION

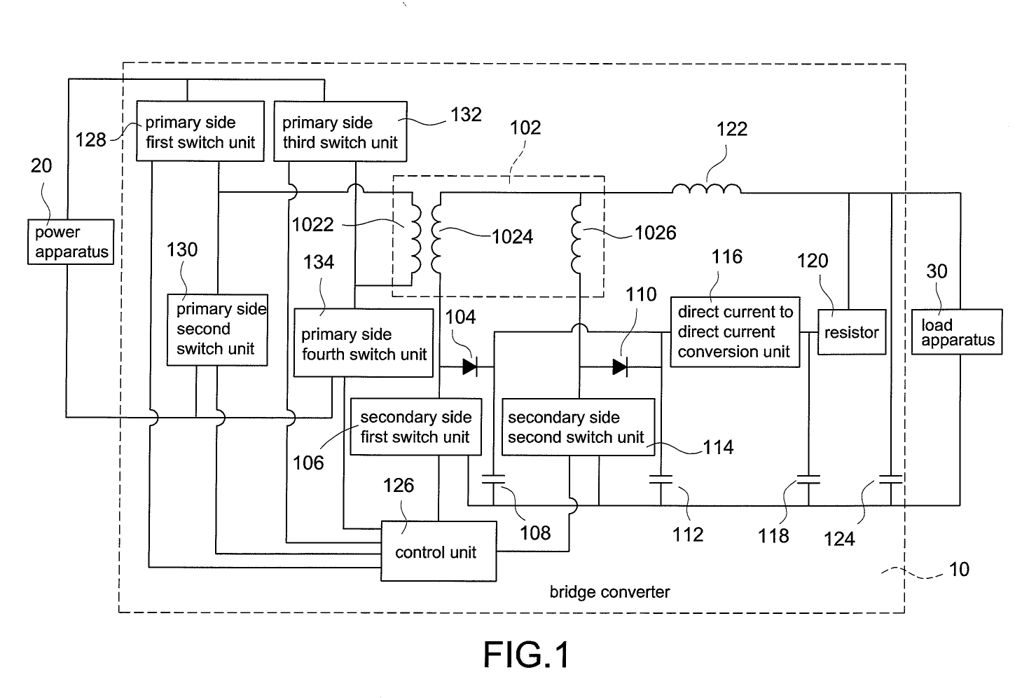

FIG. 1 shows a block diagram of the bridge converter of the present invention. A bridge converter 10 with a snubber circuit is applied to a power apparatus 20 and a load apparatus 30. The bridge converter 10 is electrically connected to the power apparatus 20 and the load apparatus 30.

The bridge converter 10 comprises a transformer 102, a first diode 104, a secondary side first switch unit 106, a first capacitor 108, a second diode 110, a second capacitor 112, a secondary side second switch unit 114, a direct current to direct current conversion unit 116, a third capacitor 118, a resistor 120, a choke 122, a fourth capacitor 124, a control unit 126, a primary side first switch unit 128, a primary side second switch unit 130, a primary side third switch unit 132 and a primary side fourth switch unit 134.

The transformer 102 comprises a primary side winding 1022, a first secondary side winding 1024 and a second secondary side winding 1026.

The first diode 104 is electrically connected to the first secondary side winding 1024. The secondary side first switch unit 106 is electrically connected to the first secondary side winding 1024, the first diode 104 and the load apparatus 30. The first capacitor 108 is electrically connected to the first diode 104, the secondary side first switch unit 106 and the load apparatus 30. The second diode 110 is electrically connected to the second secondary side winding 1026, the first diode 104 and the first capacitor 108.

The second capacitor 112 is electrically connected to the first diode 104, the second diode 110, the first capacitor 108, the secondary side first switch unit 106 and the load apparatus 30. The secondary side second switch unit 114 is electrically connected to the second secondary side winding 1026, the second diode 110, the first capacitor 108, the second capacitor 112, the secondary side first switch unit 106 and the load apparatus 30. The direct current to direct current conversion unit 116 is electrically connected to the first diode 104, the second diode 110, the first capacitor 108 and the second capacitor 112.

The third capacitor 118 is electrically connected to the direct current to direct current conversion unit 116, the first capacitor 108, the second capacitor 112, the secondary side first switch unit 106, the secondary side second switch unit 114 and the load apparatus 30. The resistor 120 is electrically connected to the direct current to direct current conversion unit 116, the third capacitor 118 and the load apparatus 30. The choke 122 is electrically connected to the first secondary side winding 1024, the second secondary side winding 1026, the resistor 120 and the load apparatus 30.

The fourth capacitor 124 is electrically connected to the choke 122, the resistor 120, the first capacitor 108, the second capacitor 112, the third capacitor 118, the secondary side first switch unit 106, the secondary side second switch unit 114 and the load apparatus 30. The control unit 126 is electrically connected to the secondary side first switch unit 106 and the secondary side second switch unit 114. The primary side first switch unit 128 is electrically connected to the control unit 126, the power apparatus 20 and the primary side winding 1022.

The primary side second switch unit 130 is electrically connected to the control unit 126, the power apparatus 20, the primary side winding 1022 and the primary side first switch unit 128. The primary side third switch unit 132 is electrically connected to the control unit 126, the power apparatus 20, the primary side winding 1022 and the primary side first switch unit 128. The primary side fourth switch unit 134 is electrically connected to the control unit 126, the power apparatus 20, the primary side winding 1022, the primary side second switch unit 130 and the primary side third switch unit 132.

The control unit 126 is, for example but not limited to, a microprocessor or a microcontroller. The secondary side first switch unit 106 is, for example but not limited to, a metal oxide semiconductor field effect transistor, a bipolar junction transistor, an insulation gate bipolar transistor or a silicon controlled rectifier. The secondary side second switch unit 114 is, for example but not limited to, a metal oxide semiconductor field effect transistor, a bipolar junction transistor, an insulation gate bipolar transistor or a silicon controlled rectifier.

The primary side first switch unit 128 is, for example but not limited to, a metal oxide semiconductor field effect transistor, a bipolar junction transistor, an insulation gate bipolar transistor or a silicon controlled rectifier. The primary side second switch unit 130 is, for example but not limited to, a metal oxide semiconductor field effect transistor, a bipolar junction transistor, an insulation gate bipolar transistor or a silicon controlled rectifier. The primary side third switch unit 132 is, for example but not limited to, a metal oxide semiconductor field effect transistor, a bipolar junction transistor, an insulation gate bipolar transistor or a silicon controlled rectifier. The primary side fourth switch unit 134 is, for example but not limited to, a metal oxide semiconductor field effect transistor, a bipolar junction transistor, an insulation gate bipolar transistor or a silicon controlled rectifier.

The voltage conversion efficiency of the direct current to direct current conversion unit 116 is high. Therefore, the peak voltage is reduced and the current is stored in the third capacitor 118 according to the direct current to direct current conversion unit 116, the third capacitor 118 and the resistor 120.

The resistor 120 can be changed to fine trim the discharging of the third capacitor 118 according to the output voltage (the load requirement). The resistance of the resistor 120 is small because the converted voltage is low. Therefore, the working temperature of the bridge converter 10 is decreased, the energy consumption is reduced, and the overall efficiency is improved.

The first diode 104 and the first capacitor 108 absorb the spike energy of the secondary side first switch unit 106 to protect the secondary side first switch unit 106. The second diode 110 and the second capacitor 112 absorb the spike energy of the secondary side second switch unit 114 to protect the secondary side second switch unit 114. The spike energy is absorbed and outputted through the direct current to direct current conversion unit 116, the third capacitor 118 and the resistor 120. The spike energy stored in the first capacitor 108 and the second capacitor 112 is recycled for outputting. The present invention is better than any prior arts because the energy stored in the first capacitor 108 and the second capacitor 112 is converted to the third capacitor 118 through the direct current to direct current conversion unit 116.

An embodiment of the present invention is as following. Assume 2 watts energy stored in the first capacitor 108 and the second capacitor 112 shall be converted and sent to the output side. The voltages of the first capacitor 108 and the second capacitor 112 are clamped at 60 volts for a converter which outputs 12 volts. Assume that the efficiency of the direct current to direct current conversion unit 116 is 90%. Then, the direct current to direct current conversion unit 116 converts the 2 watts energy mentioned above into 1.8 watts (2*0.9=1.8). The 1.8 watts energy will be stored in the third capacitor 118. The third capacitor 118 is designed so that the voltage of the third capacitor 118 is 13 volts, which is near the output voltage 12 volts to improve the efficiency, when storing the energy. Therefore, a current with 0.138 (1.8/13=0.138) amperes will flow through the resistor 120. The resistance of the resistor 120 is 7.25 ohms ((13−12)/0.138=7.25). The energy consumption of the resistor 120 is 0.14 watt (0.138*0.138*7.25=0.14). Therefore, the energy conversion is 1.66 watts (1.8−0.14=1.66). The conversion efficiency is 83% (1.66/2=0.83), which is better than any prior arts.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A bridge converter with a snubber circuit, the bridge converter applied to a power apparatus and a load apparatus, the bridge converter electrically connected to the power apparatus and the load apparatus, the bridge converter comprising:
a transformer comprising a primary side winding, a first secondary side winding and a second secondary side winding;
a first diode electrically connected to the first secondary side winding;
a secondary side first switch unit electrically connected to the first secondary side winding, the first diode and the load apparatus;
a first capacitor electrically connected to the first diode, the secondary side first switch unit and the load apparatus;
a second diode electrically connected to the second secondary side winding, the first diode and the first capacitor;
a second capacitor electrically connected to the first diode, the second diode, the first capacitor, the secondary side first switch unit and the load apparatus;
a secondary side second switch unit electrically connected to the second secondary side winding, the second diode, the first capacitor, the second capacitor, the secondary side first switch unit and the load apparatus;
a direct current to direct current conversion unit electrically connected to the first diode, the second diode, the first capacitor and the second capacitor;
a third capacitor electrically connected to the direct current to direct current conversion unit, the first capacitor, the second capacitor, the secondary side first switch unit, the secondary side second switch unit and the load apparatus; and
a resistor electrically connected to the direct current to direct current conversion unit, the third capacitor and the load apparatus.

2. The bridge converter in claim 1, further comprising:
a choke electrically connected to the first secondary side winding, the second secondary side winding, the resistor and the load apparatus.

3. The bridge converter in claim 2, further comprising:
a fourth capacitor electrically connected to the choke, the resistor, the first capacitor, the second capacitor, the third capacitor, the secondary side first switch unit, the secondary side second switch unit and the load apparatus.

4. The bridge converter in claim 3, further comprising:
a control unit electrically connected to the secondary side first switch unit and the secondary side second switch unit.

5. The bridge converter in claim 4, further comprising:
a primary side first switch unit electrically connected to the control unit, the power apparatus and the primary side winding.

6. The bridge converter in claim 5, further comprising:
a primary side second switch unit electrically connected to the control unit, the power apparatus, the primary side winding and the primary side first switch unit.

7. The bridge converter in claim 6, further comprising:
a primary side third switch unit electrically connected to the control unit, the power apparatus, the primary side winding and the primary side first switch unit.

8. The bridge converter in claim 7, further comprising:
a primary side fourth switch unit electrically connected to the control unit, the power apparatus, the primary side winding, the primary side second switch unit and the primary side third switch unit.

9. The bridge converter in claim 8, wherein the control unit is a microprocessor or a microcontroller.

10. The bridge converter in claim 9, wherein the secondary side first switch unit is a metal oxide semiconductor field effect transistor, a bipolar junction transistor, an insulation gate bipolar transistor or a silicon controlled rectifier; the secondary side second switch unit is a metal oxide semiconductor field effect transistor, a bipolar junction transistor, an insulation gate bipolar transistor or a silicon controlled rectifier; the primary side first switch unit is a metal oxide semiconductor field effect transistor, a bipolar junction transistor, an insulation gate bipolar transistor or a silicon controlled rectifier; the primary side second switch unit is a metal oxide semiconductor field effect transistor, a bipolar junction transistor, an insulation gate bipolar transistor or a silicon controlled rectifier; the primary side third switch unit is a metal oxide semiconductor field effect transistor, a bipolar junction transistor, an insulation gate bipolar transistor or a silicon controlled rectifier; the primary side fourth switch unit is a metal oxide semiconductor field effect transistor, a bipolar junction transistor, an insulation gate bipolar transistor or a silicon controlled rectifier.
